(19) United States
(12) Patent Application Publication
(10) Pub. No.: US 2007/0273680 A1
(43) Pub. Date: Nov. 29, 2007

(54) METHOD FOR ADJUSTING VISIBILITY OF A DISPLAY AND SYSTEM THEREOF

(75) Inventors: Ming Sheng Yang, Taipei City (TW); Heng Cheng Chu, Taichung City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/752,161

(22) Filed: May 22, 2007

(30) Foreign Application Priority Data
May 23, 2006 (TW) TW95118257

(51) Int. Cl. G09G 5/00

(52) U.S. Cl. 345/207

(57) ABSTRACT

Accordingly, a method of adjusting the visibility of a display is disclosed. The method comprises detecting whether any button is pressed. If a button is pressed, a display shows a first group of pictures and the back light is ignited. A surrounding luminance is compared with a first threshold. If the surrounding luminance is larger than the first threshold, a second group of pictures is presented on the display. The second group of pictures is typically less complex than the first group of pictures. The surrounding luminance is further compared with a second threshold. If the surrounding luminance is larger than the second threshold, the back light is intensified to increase the visibility of the images.

### BACKGROUND OF THE INVENTION

### Field of the Invention

The invention is related to adjusting contrast of a display, and more particularly to adjusting the visibility of a display according to surrounding luminance.

The development of electronic devices, such as mobile phones, is increasing rapidly.

Typically, in a place with high luminance such as under intense sunlight, images, particularly color images, on the display of a portable device, such as a mobile phone, is inaccurate. A user may need to adjust the backlight or move to a more suitable location. Adjusting the back light or moving to another location place may sometimes be inconvenient for the user.

### BRIEF SUMMARY OF THE INVENTION

Accordingly, methods of adjusting the visibility of the display according to surrounding luminance are provided.

The method comprises activating a mobile phone, for example, detecting whether any button of the mobile phone is pressed. If a button is pressed, a display shows a first group of pictures and activates the back light. If no button is pressed, the display continuously shows the first group of the pictures. A surrounding luminance is then detected. The surrounding luminance is compared with a first threshold. If the surrounding luminance is larger than the first threshold, a second group of pictures is shown by the display. The second group of pictures may be transformed from the first group of pictures. The surrounding luminance is further compared with a second threshold. If the surrounding luminance is larger than the second threshold, the back light is intensified to increasing the visibility of the second group of pictures.

A system with visibility adjustable according to the surrounding luminance is provided. The system comprises a light detector, an analog/digital converter (A/D), a memory, an input device, a processor, a display, and a back light module. The memory stores a first and a second threshold, a first group of pictures and a second group of pictures. The light detector detects the surrounding luminance of the system and generates a luminance signal indicating the surrounding luminance. The analog/digital converter converts the luminance signal into a digital signal. The digital signal is sent to the processor. At first, the display shows a first group of pictures. After the processor detects the system is activating by a user. For example, pressed a button of the input device or opened a flip phone. The light detector starts to detect surrounding luminance. The processor compares the surrounding luminance with a first threshold. If the surrounding luminance is larger than the first threshold, a second group of pictures are retrieved from the memory and are shown on the display. The second group of pictures is less complex than the first group of pictures, thus, showing the second group of pictures can improve the visibility of the display, especially under direct sunlight. When the surrounding luminance is larger than a second threshold, the brightness of the back light module is intensified.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the invention.

FIG. 1 shows a block diagram of a system 10 according to an embodiment of the invention;

FIG. 2 shows a flowchart of the visibility-adjusting method;

FIG. 3 shows an example of the first group of pictures and the second group of pictures; and

FIGS. 4a-4d show other embodiments of adjusting the visibility of a display.

### DETAILED DESCRIPTION OF THE INVENTION

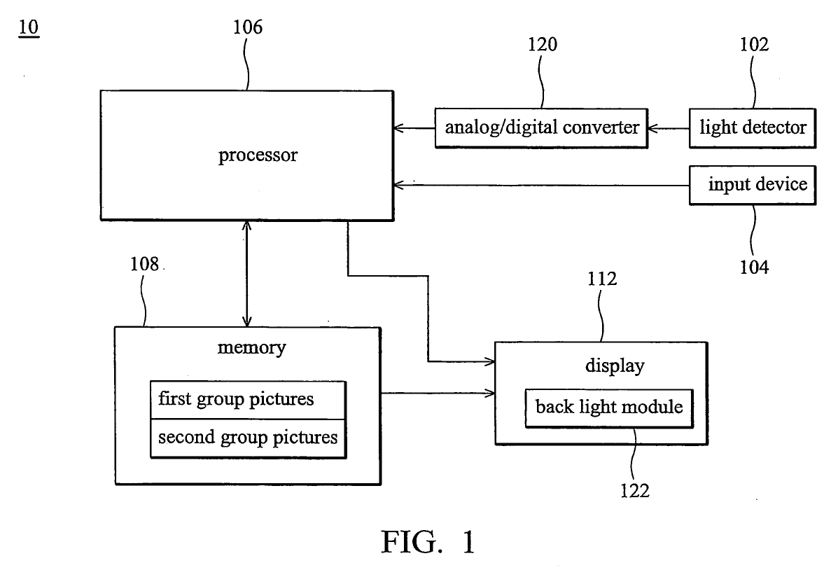

FIG. 1 shows a block diagram of a system 10 according to an embodiment of the invention. The visibility of the system 10 can be adjusted according to surrounding luminance. The system 10 comprises a light detector, an analog/digital converter (A/D) 120, a memory 108, an input device 104, a processor 106, a display 112, and a back light module 122. The memory 108 stores a first and a second threshold, a first group of pictures and a second group of pictures. The light detector 102 detects the surrounding luminance of the system and generates a luminance signal indicating the surrounding luminance. The analog digital converter 120 converts the luminance signal into a digital signal. The digital signal is sent to the processor 106. The input device 104 is an interface between the system 10 and outsides. In this embodiment, the input device 104 is a keyboard. In other embodiments, the input device 104 may be a mouse, vibration detector, light detector, etc. At first, the display 112 shows a first group of pictures. After the processor 106 detects any button of the input device 104 is pressed, the light detector 102 starts to detect surrounding luminance. The processor 106 compares the surrounding luminance with a first threshold. If the surrounding luminance is larger than the first threshold, a second group of pictures are retrieved from the memory 108 and are shown on the display 112. The memory 108 may be a machine readable memory. In this embodiment, the memory 108 is a flash. The second group of pictures is less complex than the first group of pictures. Thus, showing the second group of pictures can improve the visibility of the display, especially under direct sunlight. When the surrounding luminance is brighter than a second threshold, the brightness of the back light module 122 is increased.

In an embodiment of the invention, the system disclosed in FIG. 1 can be a mobile phone, and the first and second groups of pictures are a first man-machine interface (MMI) and a second man-machine interface, respectively.

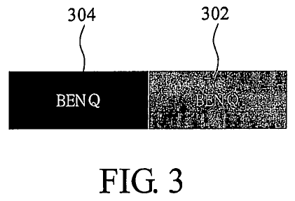

FIG. 3 shows an example of the first group of pictures and the second group of pictures. Picture 302 and picture 304 represent the MMI and the second MMI, respectively. Picture 302 has white text with gray background. Picture 304 has the same white text with black background. Since the background color in picture 304 is darker than the background color in picture 302, the text in 304 looks more clear than in 302.

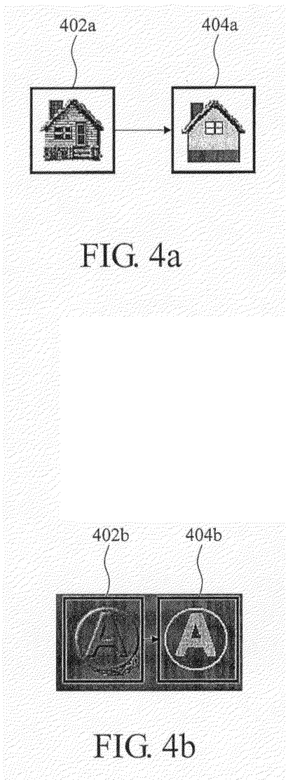

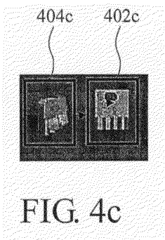

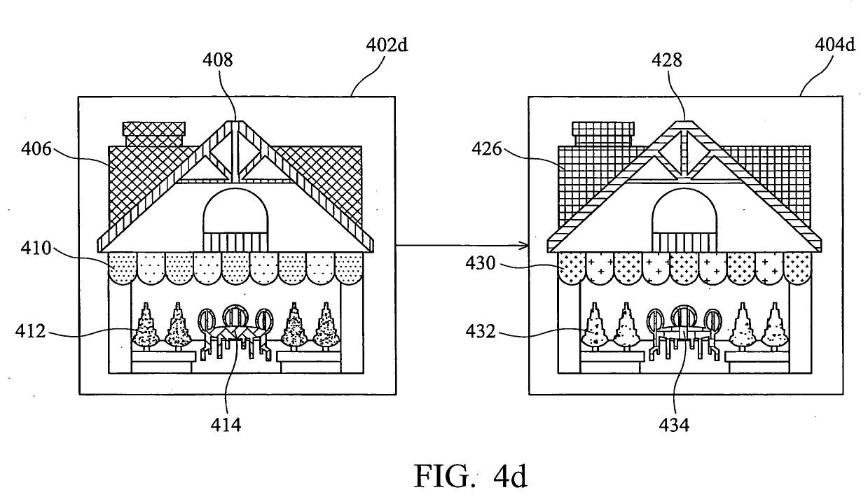

In general, the second group of pictures has less lines, less color levels or higher brightness than the first group of pictures. FIGS. 4a-4d further show other embodiments of adjusting the visibility of a monitor. In FIG. 4a, picture 402a shows one symbol of the first MMI, and picture 404a shows one symbol of the second MMI. Both the lines and color levels of picture 404a are less than those of the picture 402a. Thus, the picture 404a is more visible than picture 402a. Reducing the lines of pictures may be realized by transforming 3D pictures into 2D pictures. FIG. 4b shows an 3D picture and a simplified 3D picture. Picture 402b is a 3D image with shadows and transparency. Picture 404b is a simplified 402b with skipped shadow and higher brightness. Picture 404c in FIG. 4c shows another example of the first MMI, and picture 402c shows an example of the second MMI. Picture 404c is a 3D picture, and picture 402c is a 2D picture. Picture 402d in FIG. 4d shows yet another example of the first MMI, and 404d is an example of the second MMI. Picture 404d has higher brightness than picture 402d, thus, picture 404d appears more contrast than picture 402d. For example, the sections 406, 408, 410, 412 and 414 in 402d are corresponding to sections 426, 428, 430, 432, and 434 in 404d respectively. The section 406 and 414 are brown, section 408 is dark brown, section 410 is violet, and section 412 is dark green. Picture 404d is a brighter version of 402d. The section 426 is red, section 428 is yellow, section 432 is green, and section 434 is bisque. Note that the colors in 404d and 402d are embodiments of the invention, and the invention is not limited thereto. Other color combinations with high brightness or high saturation are also in the scope of the invention. Furthermore, the color descriptions of FIG. 4d are for ease of explanation, and the invention is not limited to replacing brown, violet, dark green by red, yellow, and green. Other color descriptions indicating similar tones can also be applied in the invention. For example, the brown in picture 402d may be caramel, amber, etc. The red in picture 404d may be brick, vermilion, etc. The techniques of simplifying pictures shown in FIG. 4a-4d can be combined to maximize the performance. For example, a picture can be flattened from 3D to 2D, and enhanced in brightness, and reduced color levels. The pictures in FIG. 4a-4d are for providing a further understanding of the invention, hence the invention is not limited thereto.

In some embodiments, the light detector 102 can be realized by a Charge Coupled Device (CCD) sensor or complementary Metal Oxide Semiconductor (CMOS) sensor

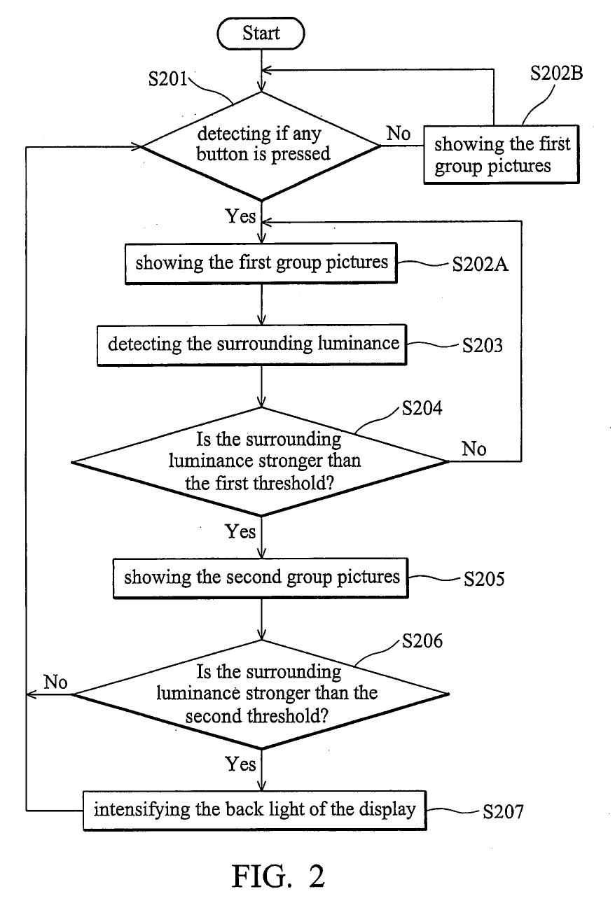

A method for adjusting visibility of a display is also provided. In some embodiments, the method can be applied on a display of a mobile phone, and the display is used to present a man-machine interface. FIG. 2 shows a flowchart of the visibility adjusting method. First, it is detected whether any button is pressed in step S201. If a button is pressed, in step S202A, a display shows a first group of pictures triggering the back light. If on button is pressed, the display continuously shows the first group of pictures in step S202B. In step S203, a surrounding luminance is detected. The surrounding luminance is compared with a first threshold in step S204. If the surrounding luminance is less than the first threshold, the method returns to step S202A. If the surrounding luminance is larger than the first threshold, a second group of pictures is shown by the display. The second group of pictures looks clearer than the first group of pictures, especially under a direct sunlight. The second group of pictures is typically transformed from the first group of pictures. For example, the second group of pictures has fewer color levels than the color levels of the first group of pictures. In other embodiments of the invention, the chroma of the second group of pictures is higher than the chroma of the first group of pictures. In some embodiments of the invention, there are fewer lines in second group of pictures than in the first group of pictures. In step S206, the surrounding luminance is further compared with a second threshold. If the surrounding luminance is larger than the second threshold, the amount of back light is increased in step S207 to enhance contrast. If the surrounding luminance is less than the second threshold, the method returns to step S201.

In addition to adjusting back light or moving to other places, a method provided by the invention allows users to more easily distinguish images on a display. The method consumes less power than just increasing the amount of back light.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for adjusting a display, comprising:
(a) showing a first group of pictures on the display;
(b) detecting a surrounding luminance; and
(c) showing a second group of pictures on the display instead when the surrounding luminance is larger than a first threshold.

2. The method as claimed in claim 1, further comprising:
showing the first group of pictures when the surrounding luminance is lower than the first threshold.

3. The method as claimed in claim 1, wherein the second group of pictures have fewer lines than the first group of pictures.

4. The method as claimed in claim 1, the step (a) further comprising:
activating the display.

5. The method as claimed in claim 4, further comprising:
pressing a button of the display.

6. The method as claimed in claim 1, further comprising:
intensifying the luminance of a back light module of the display when the surrounding luminance exceeds a second threshold, wherein the second threshold is larger than the first threshold.

7. A displaying system, comprising:
a light detector detecting a surrounding luminance and generating a surrounding luminance signal indicating the surrounding luminance;
a memory storing a first threshold, a first group of pictures and a second group of pictures;
a processor receiving the surrounding luminance signal, comparing with the first threshold signal, and output a comparing result; and
a display selectively showing the first and the second group of pictures according to the comparing result.

8. The system as claimed in claim 7, wherein the display shows the second group of pictures when the surrounding luminance is larger than the first threshold.

9. The system as claimed in claim 7, further comprising a input device, wherein the input device is a keyboard, and the keyboard comprises at least one button, once the processor detects any button is stroked, the light detector starts to detecting the surrounding luminance.

10. The system as claimed in claim 7, wherein the display further comprises a back light, the memory further stores a second threshold, and when the surrounding luminance is larger than the surrounding luminance, the luminance of the back light is intensified.

11. The system as claimed in claim 7, wherein the second group of pictures has fewer lines than the first group of pictures.

12. The system as claimed in claim 7, wherein the second group of pictures has fewer color levels of the first group of pictures.

13. The system as claimed in claim 7, wherein the chroma of the second group of pictures is higher than the chroma of the first group of pictures.

14. The system as claimed in claim 7, wherein the second group of pictures are 2D pictures, and the first group of pictures are 3D pictures.

15. The system as claimed in claim 7, wherein the system is a mobile phone with a camera, and the light detector is the camera.

16. The system as claimed in claim 7, wherein the memory is a flash.

17. The system as claimed in claim 7, further comprises an A/D converter, and the A/D converter transforms the surrounding luminance into a digital version and sends the digit surrounding luminance to the processor.
